(19) United States
(12) Patent Application Publication
(10) Pub. No.: US 2011/0157597 A1
(43) Pub. Date: Jun. 30, 2011

(54) SWEPT SOURCE OPTICAL COHERENCE TOMOGRAPHY (SS-OCT) SYSTEM AND METHOD FOR PROCESSING OPTICAL IMAGING DATA

(75) Inventors: Chih-Wei Lu, Taipei County (TW); Wei-Hao Huang, Tainan City (TW); Fu-Chiang Jan, Miaoli County (TW); Chih-Hao Liu, Taichung City (TW); Kai-Che Liu, Kaohsiung City (TW)

(73) Assignee: INDUSTRIAL TECHNOLOGY RESEARCH INSTITUTE, Hsinchu (TW)

(21) Appl. No.: 12/649,338

(22) Filed: Dec. 30, 2009

(51) Int. Cl. G01B 9/02

(52) U.S. Cl. 356/479

(57) ABSTRACT

A method for processing optical imaging data is provided. The method includes performing a phase error calibration procedure, performing a data acquisition procedure, and performing an imaging computation & analysis procedure. A reference clock signal and an A-scan signal are both received by a data acquisition unit during the phase error calibration procedure while only the A-scan signal is received by the data acquisition unit during the data acquisition procedure. A SS-OCT system for performing the above-mentioned method is provided also. Furthermore, a SS-OCT system having synchronization processing unit therein is provided.

### BACKGROUND OF THE INVENTION

1. Field of the Invention

The present invention relates to an Optical Coherence Tomography (OCT) system and method for processing optical imaging data. More particular, the present invention relates to a Swept Source Optical Coherence Tomography (SS-OCT) system and method for processing optical imaging data.

2. Description of Related Art

Generally, Optical Coherence Tomography (OCT), Magnetic Resonance Imaging (MRI), and confocal microscopy are used to inspect the interior of tissue so as to obtain 3D perspective images of the tissue. In comparison with OCT, inspection resolution of MRI is much poor and developer is necessary for MRI. Accordingly, OCT having fine resolution and less side effect becomes main stream gradually.

Conventional Fourier Domain Optical Coherence Tomography (FD-OCT) can be classified into Spectral Domain Optical Coherence Tomography (SD-OCT) and Swept Source Optical Coherence Tomography (SS-OCT). It is noted that broadband light source is used in SD-OCT system while narrowband light source is used in SS-OCT system. Specifically, all the frequency bands of single A-scan signal are captured and gathered simultaneously by 1D or 2D camera in SD-OCT system because broadband light source is used for inspection. In SD-OCT system, data processing starts once the frequency bands of single A-scan signal are captured and gathered. Accordingly, the frame rate of SD-OCT system is high.

On the contrary, each of the frequency bands of single A-scan signal is captured sequentially and gathered in SD-OCT because narrowband light source is used for inspection. In SS-OCT system, data processing starts only until all A-scan signals constituting a frame are captured and gathered. Accordingly, the frame rate of SD-OCT system is low.

Research and development of real-time image display of OCT systems are helpful to medical diagnosis or other applications. In re U.S. Publication No. 2009/0093980, a real-time SD-OCT with distributed acquisition and processing is proposed, wherein at least two processors or computers are used in the disclosed real-time SD-OCT so as to obtain high frame rate. However, the distributed acquisition and processing mentioned in U.S. Publication No. 2009/0093980 is not applicable to conventional SS-OCT system. In addition, manufacturing cost of the SS-OCT system disclosed in U.S. Publication No. 2009/0093980 is highly relevant to the quantity of processors or computers used therein.

Since the frame rate of conventional SS-OCT system cannot significantly increase, real-time image display is not practical in conventional SS-OCT system. Therefore, how to increase frame rate of conventional SS-OCT system is an important issue required to be solved.

### SUMMARY OF THE INVENTION

The present application is directed to a method for processing optical imaging data.

The present application is directed to a Swept Source Optical Coherence Tomography (SS-OCT) system.

The present application provides a method for processing optical imaging data. The method for processing optical imaging data includes performing a phase error calibration procedure, performing a data acquisition procedure, and performing an imaging computation & analysis procedure. A reference clock signal and an A-scan signal are both received by a data acquisition unit during the phase error calibration procedure while only the A-scan signal is received by the data acquisition unit during the data acquisition procedure.

The present application provides a swept source optical coherence tomography (SS-OCT) system for inspecting a sample. The SS-OCT system includes an optical unit for obtaining an interference pattern corresponding to the sample, a photo detector for capturing the interference pattern and outputting an A-scan signal corresponding to the interference pattern, a reference clock generator for providing a reference clock signal to the optical unit, and an image processing & control unit. The image processing & control unit is electrically connected with the optical unit, the photo detector and the reference clock generator. The image processing & control unit processes the A-scan signal and outputs a control signal to the optical unit according to the A-scan signal and the reference clock signal. The image processing & control unit includes a data acquisition unit for receiving the reference clock signal and the A-scan signal, an imaging computation & analysis unit electrically connected with the data acquisition unit, and an analog output unit electrically connected with data acquisition unit, the imaging computation & analysis unit and the optical unit. The data acquisition unit is suitable for performing a phase error calibration procedure and a data acquisition procedure, the reference clock signal and the A-scan signal are both received by the data acquisition unit during the phase error calibration procedure while only the A-scan signal is received by the data acquisition unit during the data acquisition procedure.

The present application provides a swept source optical coherence tomography (SS-OCT) system for inspecting a sample. The SS-OCT system includes an optical unit for obtaining an interference pattern corresponding to the sample, a photo detector for capturing the interference pattern and outputting an A-scan signal corresponding to the interference pattern, and an image processing & control unit electrically connected with the optical unit and the photo detector. The image processing & control unit processes the A-scan signal and outputs a control signal and a reference clock signal to the optical unit according to the A-scan signal. The image processing & control unit includes a data acquisition unit for receiving the A-scan signal, an imaging computation & analysis unit electrically connected with the data acquisition unit, and a synchronization processing unit electrically connected with data acquisition unit, the imaging computation & analysis unit and the optical unit. The synchronization processing unit outputs the reference clock signal and the control signal. The reference clock signal and the control signal output from the synchronization processing unit are synchronized.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematically view illustrating the SS-OCT system according to an embodiment of the present application.

FIG. 1B is a schematically view illustrating the SS-OCT system according to another embodiment of the present application.

FIG. 2 schematically shows the relationship of the control signal, the reference clock signal and the A-scan signal ideally and practically.

FIG. 3A is a flowchart illustrating the method for processing optical imaging data according to an embodiment of the present application.

FIG. 3B is a flowchart illustrating the method for processing optical imaging data according to another embodiment of the present application.

FIG. 4 is a schematically view illustrating the SS-OCT system according to another embodiment of the present application.

FIG. 5 is a block diagram of the synchronization processing unit according to an embodiment of the present application.

### DESCRIPTION OF EMBODIMENTS

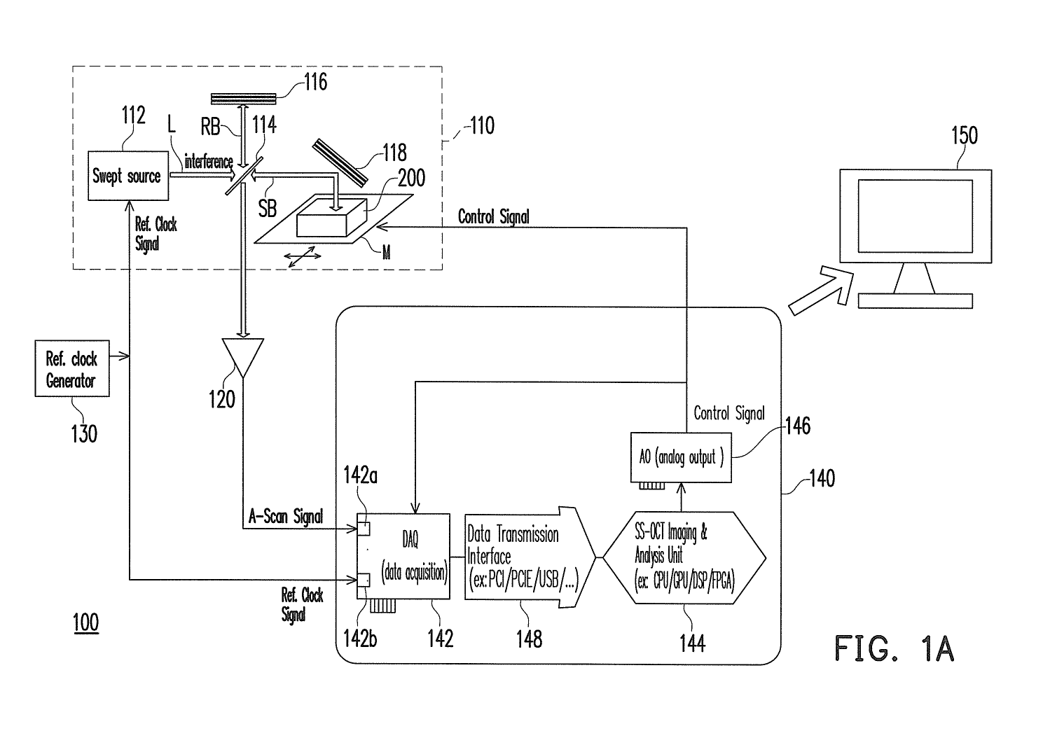

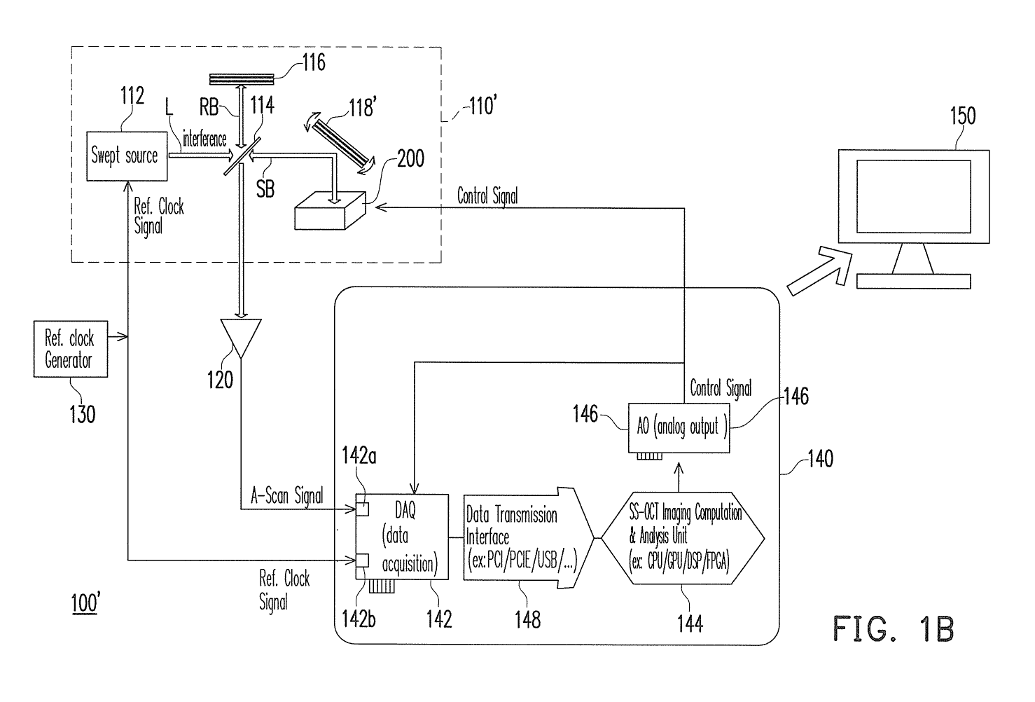

FIG. 1A is a schematically view illustrating the SS-OCT system according to an embodiment of the present application. Referring to FIG. 1A, the swept source optical coherence tomography (SS-OCT) system 100 for inspecting a sample 200 includes an optical unit 110 for obtaining an interference pattern corresponding to the sample 200, a photo detector 120 for capturing the interference pattern and outputting an A-scan signal corresponding to the interference pattern, a reference clock generator 130 for providing a reference clock signal to the optical unit 110, and an image processing & control unit 140. The image processing & control unit 140 is electrically connected with the optical unit 110, the photo detector 120 and the reference clock generator 130. The image processing & control unit 140 not only processes the A-scan signal but also outputs a control signal to the optical unit 110 according to the A-scan signal and the reference clock signal. The image processing & control unit 140 includes a data acquisition unit 142 for receiving the reference clock signal and the A-scan signal, an imaging computation & analysis unit 144 electrically connected with the data acquisition unit 142, and an analog output unit 146 electrically connected with data acquisition unit 142, the imaging computation & analysis unit 144 and the optical unit 110. The data acquisition unit 142 is suitable for performing a phase error calibration procedure and a data acquisition procedure, the reference clock signal and the A-scan signal are both received by the data acquisition unit 142 during the phase error calibration procedure while only the A-scan signal is received by the data acquisition unit 142 during the data acquisition procedure.

In this embodiment, the optical unit 110 may include a swept light source 112 for providing a light beam L, a beam splitter 114 disposed on an optical path of the light beam L, and a first reflector 116. The light beam L is split up into a sample beam SB irradiated on the sample 200 and a reference beam RB by the beam splitter 114. For example, the reference beam RB is part of the light beam L that is reflected by the beam splitter 114 is while the sample beam SB is part of the light beam L that passes through the beam splitter 114. The first reflector 116 is disposed on an optical path of the reference beam RB to reflect the reference beam RB back to the beam splitter 114. Interference pattern corresponding to the sample 200 is generated by optical interference of the sample beam SB and the reference beam RB. Specifically, interference pattern corresponding to the sample 200 is generated by optical interference of the reference beam RB reflected by the first reflector 116 and the sample beam SB reflected from the sample 200. The above-mentioned interference pattern is generated in the vicinity of the beam splitter 114. In a practical embodiment, the swept light source 112 is a swept laser source, the first reflector 116 is a reflective mirror installed above the beam splitter 114. In an alternative embodiment, the optical unit 110 may further include a second reflector 118 disposed on an optical path of the sample beam SB for reflecting the sample beam SB to the sample 200 or reflecting the sample beam SB from the sample 200 to the beam splitter 114. The second reflector 118 for reflecting the sample beam SB is an optional element in the optical unit 110. Through proper arrangement of the sample, the second reflector 118 may be omitted.

The above-mentioned interference pattern generated in the vicinity of the beam splitter 114 is captured by the photo detector 120 such that the A-scan signal corresponding to the interference pattern is output by the photo detector 120. Here, the A-scan signal is a raw signal of an OCT image and an identifiable OCT image can be obtained by properly calculating the A-scan signal (e.g. FFT calculation or other suitable calculations). The A-scan signal output from the photo detector 120 is transmitted to and processed by the image processing & control unit 140.

In order to obtain a 2D or 3D image of the sample 200, the relative position of the sample beam SB and the sample 200 is required to change continuously. In this embodiment, the optical unit 110 further includes a movable stage M for carrying the sample 200, wherein the movable stage M moves in three dimensions such that the sample beam SB is capable of irradiating on different parts of the sample 200. When the sample beam SB continuously irradiates on different parts of the sample 200, interference patterns corresponding to different parts of the sample 200 generate and are captured by the photo detector 120 continuously. Afterward, the photo detector 120 transmits the A-scan signal to the image processing & control unit 140 and the A-scan signal is transformed into a 2D or 3D image by the image processing & control unit 140.

In an embodiment of the present application, the image processing & control unit 140 may further includes a data transmission interface 148 electrically connected with the data acquisition unit 142 and the imaging computation & analysis unit 144. In an embodiment of the application, the data transmission interface 148 may be PCI interface, PCI-E interface, USB interface or other suitable interfaces. Further, the imaging computation & analysis unit 144 may be a CPU, a GPU, DSP, FPGA or other suitable processing units.

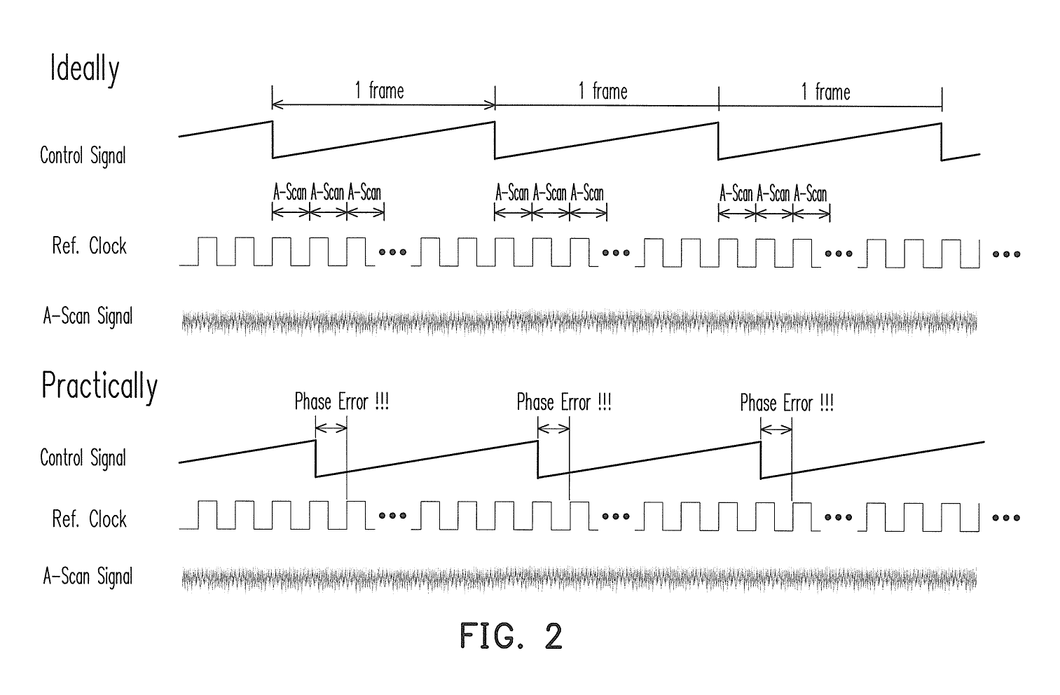

FIG. 2 schematically shows the relationship of the control signal, the reference clock signal and the A-scan signal ideally and practically. Referring to FIG. 2, the phase error between the control signal and the reference clock signal is not occurred ideally (shown in upper portion of FIG. 2), but the phase error between the control signal and the reference clock signal occurs indeed practically (shown in lower portion of FIG. 2) especially when the control signal and the reference clock signal are output from different components. In order to calibrate the phase error between the control signal and the reference clock signal, designs of the image processing & control unit 140 in the application is illustrated as followings.

In the image processing & control unit 140 of this embodiment, the data acquisition unit 142 may have an A-scan signal acquisition channel 142a for receiving the A-scan signal and a reference clock signal acquisition channel 142b for receiving the reference clock signal. Specifically, the A-scan signal acquisition channel 142a and the reference clock signal acquisition channel 142b are both turned on during the phase error calibration procedure while only the A-scan signal acquisition channel 142a is turned on during the data acquisition procedure. In other words, since the reference clock is input to the data acquisition unit 142, the control signal output by the data acquisition unit 142 and the reference clock signal are pre-synchronized during the phase error calibration procedure, but the synchronization of the control signal and the reference clock signal are not conducted during the data acquisition procedure. Obviously, the data transmission rate (amount) is low during the data acquisition procedure. Accordingly, real-time image display of OCT system is feasible. It is noted that the SS-OCT system 100 may further include a display 150 connected with the image processing & control unit 140 such that a real-time image can be displayed on the display 150.

FIG. 1B is a schematically view illustrating the SS-OCT system according to another embodiment of the present application. Referring to FIG. 1A and FIG. 1B, the SS-OCT system 100 in FIG. 1A is similar with the SS-OCT system 100′ in FIG. 1B except that a Galvo mirror 118′ is used in the optical unit 110′ of the SS-OCT system 100′. Here, the Galvo mirror 118′ is a rotatable mirror capable of enabling the sample beam SB to scan in two dimensions and irradiate on different parts of the sample 200.

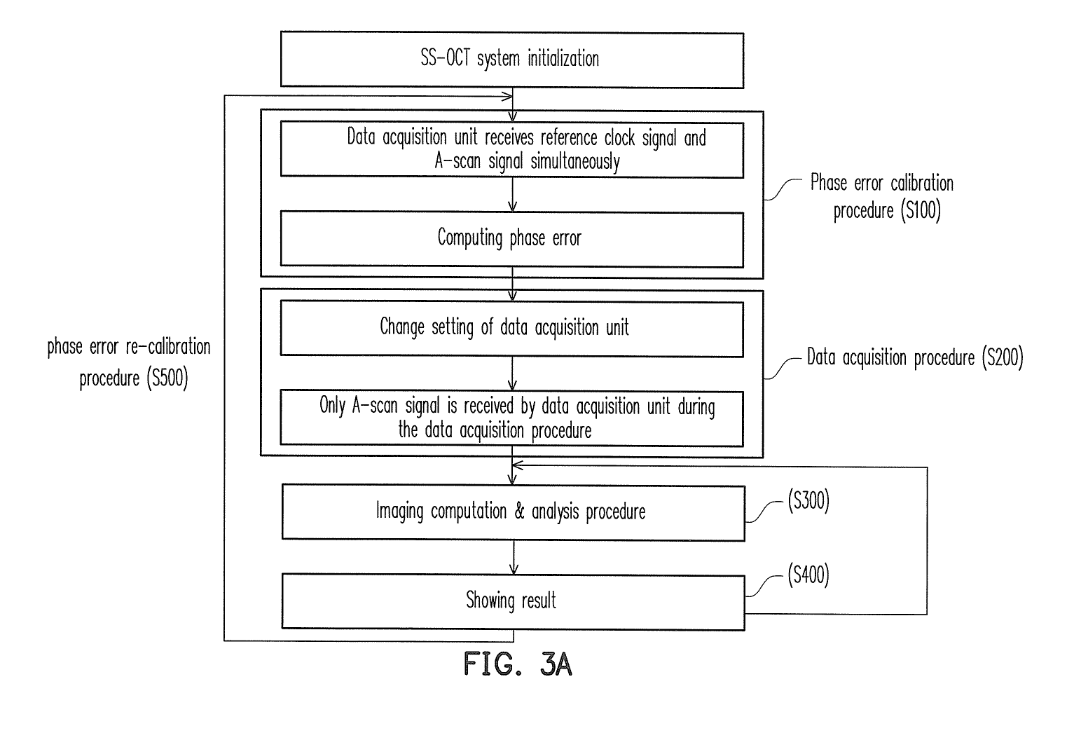

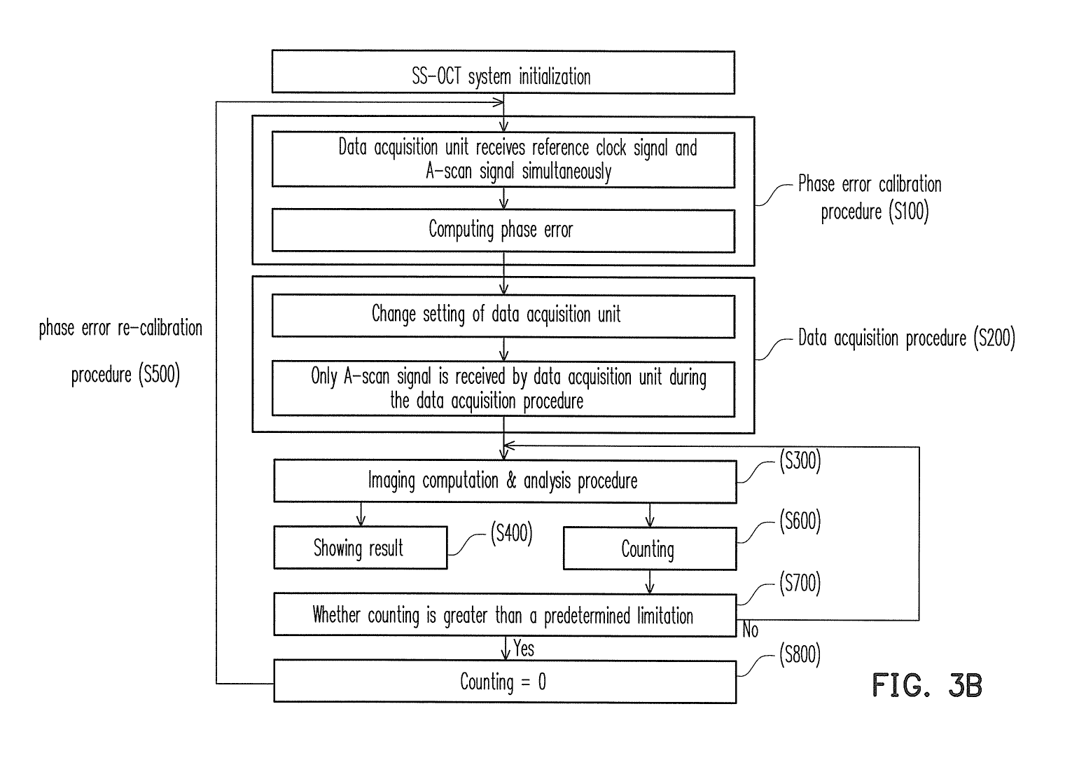

FIG. 3A is a flowchart illustrating the method for processing optical imaging data according to an embodiment of the present application. Referring to FIG. 3A, the method for processing optical imaging data in this embodiment at least includes performing a phase error calibration procedure (S100), performing a data acquisition procedure (S200), and performing an imaging computation & analysis procedure (S300). In this embodiment, the reference clock signal and the A-scan signal are both received by a data acquisition unit 142 (shown in FIG. 1A or FIG. 1B) so as to compute phase error when performing a phase error calibration procedure (S100) in advance. Additionally, the setting of the data acquisition unit 142 (shown in FIG. 1A or FIG. 1B) is changed such that only the A-scan signal is received by the data acquisition unit 142 (shown in FIG. 1A or FIG. 1B) when performing the data acquisition procedure (S200). In other words, the A-scan signal acquisition channel 142a (shown in FIG. 1A or FIG. 1B) and the reference clock signal acquisition channel 142b (shown in FIG. 1A or FIG. 1B) are set to be turned on (enabled) during the phase error calibration procedure while only the A-scan signal acquisition channel 142a is set to be turned on (enabled) during the data acquisition procedure. The reference clock signal acquisition channel 142b is set to be turned off (disabled) during the data acquisition procedure.

After performing an imaging computation & analysis procedure (S300), the analysis result is shown on a display (S400). In this embodiment, the imaging computation & analysis procedure (S300) and showing result procedure (S400) are performed continuously and repeatedly so as to obtain 2D or 3D images of the sample continuously. In addition, a phase error re-calibration procedure (S500) may be performed any time so as to maintain the inspection precision.

FIG. 3B is a flowchart illustrating the method for processing optical imaging data according to another embodiment of the present application. Referring to FIG. 3B, the method for processing optical imaging data in this embodiment is similar with that illustrated in FIG. 3A except that a counting procedure is adopted in the embodiment illustrated in FIG. 3B. Specifically, the method for processing optical imaging data in this embodiment further includes performing a counting procedure (S600) to determine whether a phase error re-calibration procedure is required (S700) and performing a phase error re-calibration procedure (S500) when a counting result of the counting procedure is greater than a predetermined limitation. More specifically, the method for processing optical imaging data in this embodiment further includes performing a counting procedure (S600) to determine whether a phase error re-calibration procedure is required (S700), resetting the counting result of the counting procedure to zero (S800), and then performing a phase error re-calibration procedure (S500) when a counting result of the counting procedure is greater than a predetermined limitation (S700).

It is noted that how to determine the time point of the phase error re-calibration procedure (S500) is not limited in the present application, counting procedure (S600) is merely an example for illustration.

Since synchronization of the reference clock signal and the A-scan signal is only performed during the phase error calibration procedure and synchronization of the reference clock signal and the A-scan signal is not performed during the data acquisition procedure, frame rate of the SS-OCT system in the present application is enhanced. Accordingly, real-time image display is feasible in the SS-OCT system of the present application.

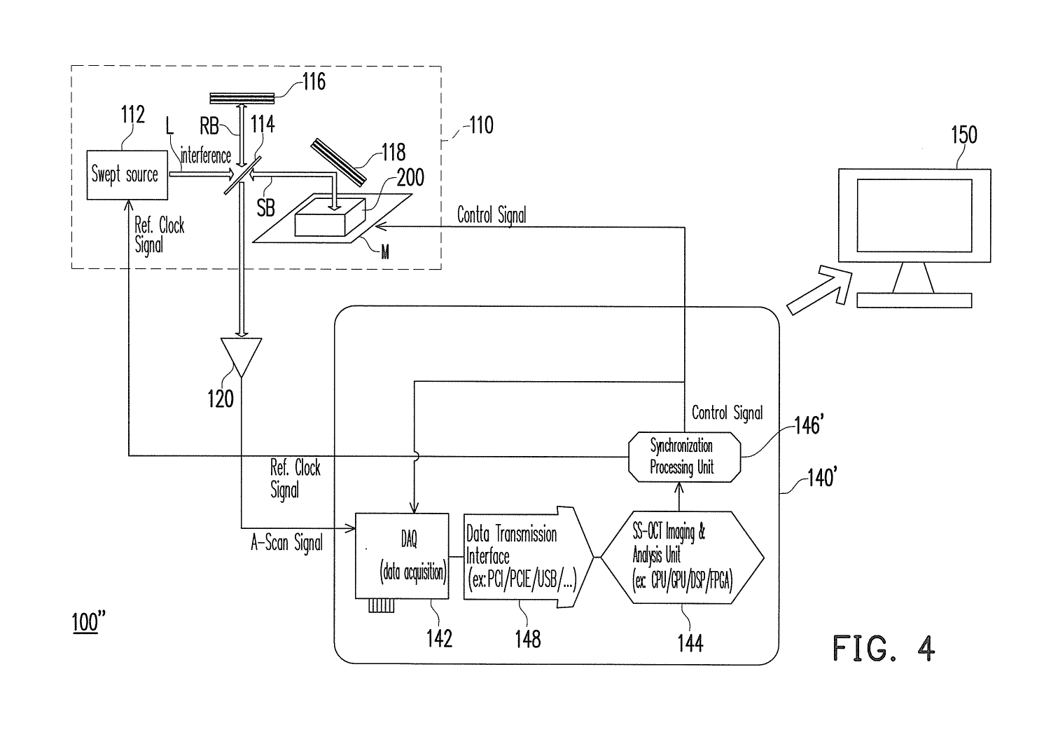

FIG. 4 is a schematically view illustrating the SS-OCT system according to another embodiment of the present application. Referring to FIG. 4, the swept source optical coherence tomography (SS-OCT) system 100″ for inspecting a sample 200 includes an optical unit 110 for obtaining an interference pattern corresponding to the sample 200, a photo detector 120 for capturing the interference pattern and outputting an A-scan signal corresponding to the interference pattern, and an image processing & control unit 140′ electrically connected with the optical unit 110 and the photo detector 120. The image processing & control unit 140′ processes the A-scan signal and outputs a control signal and a reference clock signal to the optical unit 120 according to the A-scan signal. The image processing & control unit 140′ includes a data acquisition unit 142 for receiving the A-scan signal, an imaging computation & analysis unit 144 electrically connected with the data acquisition unit 142, and a synchronization processing unit 146′ electrically connected with data acquisition unit 142, the imaging computation & analysis unit 144 and the optical unit 110. The synchronization processing unit 146′ outputs the reference clock signal and the control signal to the optical unit 110. Specifically, the reference clock signal output from the synchronization processing unit 146′ is transmitted to the swept light source 112. The reference clock signal and the control signal output from the synchronization processing unit 146′ are synchronized.

The optical unit 110 shown in FIG. 4 is not limited to be the same with the optical unit 110 shown in FIG. 1A, the optical unit 110′ illustrated in FIG. 1B or other suitable optical unit design can be used in FIG. 4 also.

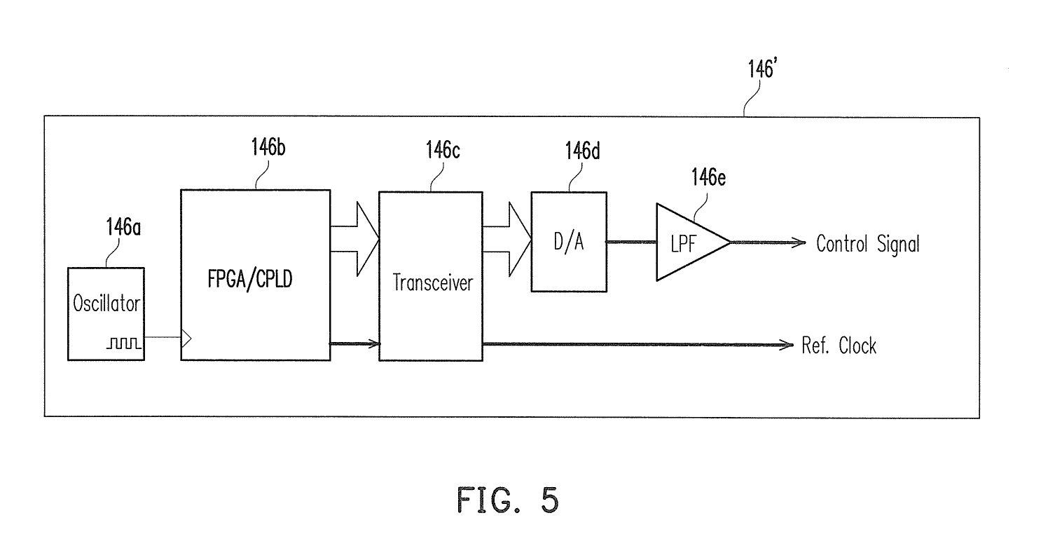

FIG. 5 is a block diagram of the synchronization processing unit according to an embodiment of the present application. Referring to FIG. 5, the above-mentioned synchronization processing unit 146′ includes an oscillator 146a, a synchronized digital signal generating block 146b, a transceiver 146c, a digital-to-analog converter 146d, and a low pass filter (LPF) 146e. A signal source is generated from the oscillator 146a and is transmitted to the synchronized digital signal generating block 146b. After receiving the signal source from the oscillator 146a, the reference clock signal and the control signal are generated by the synchronized digital signal generating block 146b, wherein the reference clock signal and the control signal are synchronized. Then, the reference clock signal and the control signal are transmitted to the transceiver 146c. Afterward, the control signal is transmitted to and processed by the digital-to-analog converter 146d and the low pass filter (LPF) 146e such that smooth and analog control signal can be obtained. In an embodiment of the present application, the synchronized digital signal generating block 146b is FPGA or CPLD, for instance. Other designs of synchronization processing unit 146′ may be selected according to actual design requirements of products.

Since the synchronization processing unit 146′ is used in the above-mentioned embodiment, frame rate of the SS-OCT system in the present application is enhanced. Accordingly, real-time image display is feasible in the SS-OCT system of the present application.

Although the invention has been described with reference to the above mentioned embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for processing optical imaging data, comprising:
performing a phase error calibration procedure, wherein a reference clock signal and an A-scan signal are both received by a data acquisition unit during the phase error calibration procedure;
performing a data acquisition procedure continuously, wherein only the A-scan signal is received by the data acquisition unit during the data acquisition procedure; and
performing an imaging computation & analysis procedure continuously.

2. The method for processing optical imaging data as claimed in claim 1, further comprising showing result continuously after performing the imaging computation & analysis procedure.

3. The method for processing optical imaging data as claimed in claim 2, further comprising:
performing a phase error re-calibration procedure after showing result.

4. The method for processing optical imaging data as claimed in claim 2, further comprising:
performing a counting procedure to determine whether a phase error re-calibration procedure is required; and
performing a phase error re-calibration procedure when a counting result of the counting procedure is greater than a predetermined limitation.

5. The method for processing optical imaging data as claimed in claim 2, further comprising:
performing a counting procedure to determine whether a phase error re-calibration procedure is required; and
resetting the counting result of the counting procedure to zero and then performing a phase error re-calibration procedure when a counting result of the counting procedure is greater than a predetermined limitation.

6. A swept source optical coherence tomography (SS-OCT) system for inspecting a sample, comprising:
an optical unit for obtaining an interference pattern corresponding to the sample;
a photo detector for capturing the interference pattern and outputting an A-scan signal corresponding to the interference pattern;
a reference clock generator for providing a reference clock signal to the optical unit;
an image processing & control unit electrically connected with the optical unit, the photo detector and the reference clock generator, wherein the image processing & control unit processes the A-scan signal and outputs a control signal to the optical unit according to the A-scan signal and the reference clock signal, and the image processing & control unit comprises:
a data acquisition unit for receiving the reference clock signal and the A-scan signal, both received by the data acquisition unit during the phase error calibration procedure while only the A-scan signal is received by the data acquisition unit during the data acquisition procedure, wherein the data acquisition unit is suitable for performing a phase error calibration procedure and a data acquisition procedure, the reference clock signal and the A-scan signal;
an imaging computation & analysis unit electrically connected with the data acquisition unit; and
an analog output unit electrically connected with data acquisition unit, the imaging computation & analysis unit and the optical unit.

7. The SS-OCT system as claimed in claim 6, wherein the image processing & control unit further comprises a data transmission interface electrically connected with the data acquisition unit and the imaging computation & analysis unit.

8. The SS-OCT system as claimed in claim 6, wherein the optical unit comprises:
a swept light source for providing a light beam;
a beam splitter disposed on an optical path of the light beam, the light beam being split up into a sample beam irradiated on the sample and a reference beam by the beam splitter; and
a first reflector disposed on an optical path of the reference beam for reflecting the reference beam back to the beam splitter, wherein the interference pattern corresponding to the sample is generated by optical interference of the sample beam and the reference beam.

9. The SS-OCT system as claimed in claim 8, wherein the optical unit further comprises a second reflector disposed on an optical path of the sample beam for reflecting the sample beam to the sample.

10. The SS-OCT system as claimed in claim 9, wherein the second reflector comprises a Galvo mirror, the Galvo mirror enables the sample beam to scan in two dimensions.

11. The SS-OCT system as claimed in claim 9, wherein the optical unit further comprises a movable stage for carrying the sample, the movable stage moves in three dimensions.

12. A swept source optical coherence tomography (SS-OCT) system for inspecting a sample, comprising:
an optical unit for obtaining an interference pattern corresponding to the sample;
a photo detector for capturing the interference pattern and outputting an A-scan signal corresponding to the interference pattern;
an image processing & control unit electrically connected with the optical unit and the photo detector, wherein the image processing & control unit processes the A-scan signal and outputs a control signal and a reference clock signal to the optical unit according to the A-scan signal, and the image processing & control unit comprises:
a data acquisition unit for receiving the A-scan signal;
an imaging computation & analysis unit electrically connected with the data acquisition unit; and
a synchronization processing unit electrically connected with data acquisition unit, the imaging computation & analysis unit and the optical unit, wherein the synchronization processing unit outputs the reference clock signal and the control signal, the reference clock signal and the control signal output from the synchronization processing unit are synchronized.

13. The SS-OCT system as claimed in claim 12, wherein the image processing & control unit further comprises a data transmission interface electrically connected with the data acquisition unit and the imaging computation & analysis unit.

14. The SS-OCT system as claimed in claim 12, wherein the optical unit comprises:
a swept light source for providing a light beam;
a beam splitter disposed on an optical path of the light beam, the light beam being split up into a sample beam irradiated on the sample and a reference beam by the beam splitter; and
a first reflector disposed on an optical path of the reference beam for reflecting the reference beam back to the beam splitter, wherein the interference pattern corresponding to the sample is generated by optical interference of the sample beam and the reference beam.

15. The SS-OCT system as claimed in claim 14, wherein the optical unit further comprises a second reflector disposed on an optical path of the sample beam for reflecting the sample beam to the sample.

16. The SS-OCT system as claimed in claim 15, wherein the second reflector comprises a Galvo mirror, the Galvo mirror enables the sample beam to scan in two dimensions.

17. The SS-OCT system as claimed in claim 15, wherein the optical unit further comprises a movable stage for carrying the sample, the movable stage moves in three dimensions.
